(19) United States
(12) Patent Application Publication
(10) Pub. No.: US 2026/0351956 A1
(43) Pub. Date: Nov. 5, 2026

(54) CIRCUIT BREAKER CONTROL METHOD AND APPARATUS, DEVICE, STORAGE MEDIUM, AND PROGRAM PRODUCT

(71) Applicants: CSG POWER GENERATION CO., LTD. MAINTENANCE AND TEST COMPANY, Guangzhou (CN); GUANGZHOU QIMING SHUZHI ENERGY TECHNOLOGY CO., LTD., Guangzhou (CN)

(72) Inventors: Mingxuan YANG, Guangzhou (CN); Yaxiong YU, Guangzhou (CN); Yu GONG, Guangzhou (CN); Qing LI, Guangzhou (CN); Hanqiu YAN, Guangzhou (CN); Yequan LIANG, Guangzhou (CN); Xiaobo QIU, Guangzhou (CN); Jialiang YU, Guangzhou (CN); Bo WAN, Guangzhou (CN); Yueying GAO, Guangzhou (CN); Weiwei PENG, Guangzhou (CN); Tao CHEN, Guangzhou (CN); Yating DENG, Guangzhou (CN); Li YE, Guangzhou (CN); Sijie WANG, Guangzhou (CN); Kaiwei XU, Guangzhou (CN); Jun PEI, Guangzhou (CN); Huan LIU, Guangzhou (CN); Yunyun CHEN, Guangzhou (CN); Shusheng LUO, Guangzhou (CN); Jialin ZOU, Guangzhou (CN); Jianhang YUAN, Guangzhou (CN); Xiaoliang LI, Guangzhou (CN); Xiao LIANG, Guangzhou (CN); Xiangwei HUANG, Guangzhou (CN); Peng LING, Guangzhou (CN); Jun JIANG, Guangzhou (CN)

(73) Assignees: CSG POWER GENERATION CO., LTD. MAINTENANCE AND TEST COMPANY, Guangzhou (CN); GUANGZHOU QIMING SHUZHI ENERGY TECHNOLOGY CO., LTD., Guangzhou (CN)

(21) Appl. No.: 19/489,609

(22) PCT Filed: Dec. 16, 2024
(86) PCT No.: PCT/CN2024/139551

§ 371 Date: Dec. 3, 2025

(30) Foreign Application Priority Data
May 24, 2024 (CN) 202410656706.7

(51) Int. Cl. H02H 7/26; H02H 7/06

(52) U.S. Cl. CPC H02H 7/262; H02H 7/06

(57) ABSTRACT

A circuit breaker control method, an apparatus, a device, a storage medium, and a program product are provided. The circuit breaker control method includes: obtaining actual rotational speed information of a target generator set; generating a frequency signal when the actual rotational speed information meets a preset rotational speed condition; obtaining state information of a target circuit breaker, and generating a pulse signal based on the frequency signal when the state information meets a preset state condition; generating a trip signal according to the pulse signal, and sending the trip signal to the target circuit breaker to control the target circuit breaker to be switched off. The present disclosure achieves intelligent switch-on control of a circuit breaker.

This application is a national stage application of PCT international application PCT/CN 2024/139551 filed on Dec. 16, 2024, which claims priority to Chinese patent application No. 2024106567067, filed on May 24, 2024, the entire contents of which are incorporated by reference.

### TECHNICAL FIELD

The present disclosure relates to the technical field of security protection for power grid, and particularly relates to a circuit breaker control method and apparatus, a computer device, a storage medium, and a program product.

### BACKGROUND

A generator set can supply power to a power grid. However, in some cases, a power supply system where the generator set is located may be overloaded or short-circuited, thereby causing dangers such as fire. In order to address such a problem, circuit breakers are invented. The circuit breaker is an important control and protection device in a low-voltage power distribution system, which can rapidly interrupt a fault current when the power distribution system is overloaded or short-circuited, therefore protecting the power distribution system and electrical equipment. In addition, the circuit breaker can also be used for infrequent on-off control. The stability and reliability of the performance of the circuit breaker are of great significance for the power distribution system, the electrical equipment, and the guarantee of personal and property safety.

However, how to intelligently control the circuit breaker to cut off a circuit in time and protect the generator set when the power supply system fails is a problem to be addressed at present.

### SUMMARY

In a first aspect, a circuit breaker control method is provided in the present disclosure, including the following steps:
obtaining actual rotational speed information of a target generator set;
generating a frequency signal when the actual rotational speed information meets a preset rotational speed condition;
obtaining state information of a target circuit breaker, and generating a pulse signal based on the frequency signal when the state information meets a preset state condition;
generating a trip signal according to the pulse signal, and sending the trip signal to the target circuit breaker to control the target circuit breaker to be switched off.

In some embodiments of the present disclosure, the rotational speed condition includes that the actual rotational speed information indicates that a first proportion of an actual rotational speed value of the target generator set does not reach a preset rotational speed value, or the actual rotational speed information indicates that the actual rotational speed value of the target generator set is not zero.

Generating the frequency signal when the actual rotational speed information meets the preset rotational speed condition includes:
generating the frequency signal when the actual rotational speed information indicates that an actual rotational speed value of the target generator set does not reach a first proportion of a preset rotational speed value, or when the actual rotational speed information reaches the first proportion of the preset rotational speed value and the actual rotational speed information indicates that the actual rotational speed value of the target generator set is not zero.

In some embodiments of the present disclosure, the state condition is that the target circuit breaker is in a switch-on position.

A pulse signal is generated based on the frequency signal when the state information meets the preset state condition, including:
generating the pulse signal based on the frequency signal when the state information indicates that the target circuit breaker is in the switch-on position.

In some embodiments of the present disclosure, the circuit breaker control method further includes the following steps:
receiving a control signal, and controlling the target circuit breaker to be switched off according to the control signal; and
the generating the trip signal according to the pulse signal, and sending the trip signal to the target circuit breaker to control the target circuit breaker to be switched off, including:
generating the trip signal, and sending the trip signal to the target circuit breaker to control the target circuit breaker to be switched off when no control signal is received within the preset time period after the pulse signal is generated.

In some embodiments of the present disclosure, the circuit breaker control method further includes the following steps:
stopping generation of the trip signal when a reset signal is obtained within a preset time period.

In some embodiments of the present disclosure, generating the reset signal includes:
obtaining the actual rotational speed information of the target generator set continuously within the preset time period after generating the pulse signal, and generating the reset signal when the actual rotational speed information indicates that the actual rotational speed value of the target generator set reaches the first proportion of the preset rotational speed value or the actual rotational speed information indicates that the actual rotational speed value of the target generator set is zero.

In a second aspect, a circuit breaker control apparatus is further provided in the present disclosure, including:
an obtaining module, configured to obtain actual rotational speed information of a target generator set;
a first generating module, configured to generate a frequency signal when the actual rotational speed information meets a preset rotational speed condition;
a second generating module, configured to obtain state information of a target circuit breaker, and generate a pulse signal based on the frequency signal when the state information meets a preset state condition;
a control module, configured to generate a trip signal according to the pulse signal, and send the trip signal to the target circuit breaker to control the target circuit breaker to be switched off.

In a third aspect, a computer device is further provided in the present disclosure. The computer device includes a memory and a processor. The memory stores a computer program. The processor, when executing the computer program, implements the circuit breaker control method in any of the above embodiments.

In a fourth aspect, a non-transitory computer-readable storage medium is further provided in the present disclosure. The computer-readable storage medium stores a computer program. The computer program, when executed by a processor, implements the circuit breaker control method in any of the above embodiments.

In a fifth aspect, a computer program product is further provided in the present disclosure. The computer program product includes a computer program. The computer program product, when executed by a processor, implements the circuit breaker control method in any of the above embodiments.

### BRIEF DESCRIPTION OF DRAWINGS

In order to more clearly illustrate the technical solutions in the embodiments of the present disclosure or conventional technologies, the following briefly describes the drawings required in the description of the embodiments or the conventional technologies. Apparently, the drawings in the following description merely involve some of the embodiments of the present disclosure, and for those of ordinary skill in the art, other drawings can also be obtained from these drawings without inventive effort.

FIG. 1 is a diagram of an application environment of a circuit breaker control method in an embodiment.

FIG. 2 is a schematic flowchart of a circuit breaker control method in an embodiment.

FIG. 3 is a schematic structural diagram of a circuit breaker control apparatus in an embodiment.

FIG. 4 is an internal structure diagram of a computer device in an embodiment.

### DETAILED DESCRIPTION

In order to make the present disclosure more comprehensible, the present disclosure will be described in more detail with reference to the accompanying drawings. The preferred embodiments of the present disclosure are shown in the drawings. However, the present disclosure can be implemented in many different forms and is not limited to the embodiments described herein. Rather, these embodiments are provided so that the disclosed content of the present disclosure can be more thorough and complete.

Unless otherwise defined, all technical and scientific terms used herein have the same meaning as commonly understood by one of ordinary skill in the art to which the present disclosure belongs. The terms used in the specification of the disclosure herein are for the purpose of describing specific embodiments only and are not intended to limit the present disclosure.

As used herein, the articles in singular forms as “a”, “an”, or “the”, are intended to include the plural forms as well, unless the context clearly indicates otherwise. It will be further understood that the terms “consist of” and/or “include”, when used in this specification, specify presence of stated features, integers, steps, operations, elements, and/or components, but do not exclude presence or addition of one or more other features, integers, steps, operations, elements, components, and/or groups thereof. Also, as used herein, the term “and/or” includes any or all combinations of one or more of the associated listed items.

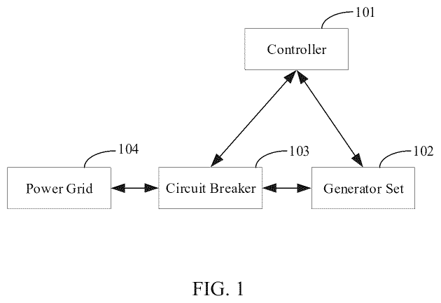

A circuit breaker control method provided in an embodiment of the present disclosure can be applied to an application environment as shown in FIG. 1. In the application environment, a controller 101 is directly or indirectly connected to a generator set 102 and a circuit breaker 103 through wired or wireless communication, for example, through a power grid 104.

For example, the circuit breaker control method is applied to the controller 101. The controller 101 obtains actual rotational speed information of a target generator set 102, and generates a frequency signal when the actual rotational speed information of the target generator set 102 meets a preset speed condition. Then, the controller 101 obtains state information of a target circuit breaker 103, and generates a pulse signal when the state information meets a preset state condition. Finally, the controller 101 generates a trip signal according to the pulse signal, and sends the trip signal to the target circuit breaker 103, so as to control the target circuit breaker 103 to be switched off.

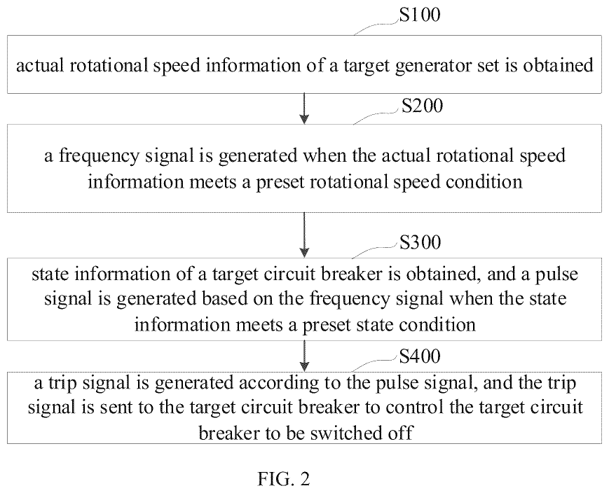

In some embodiments, a circuit breaker control method is provided. In the embodiments, taking the application of the circuit breaker control method to a controller as an example, as shown in FIG. 2, the circuit breaker control method includes steps S100-S400.

In S100, actual rotational speed information of a target generator set is obtained.

The target generator set can be a generator set for supplying power to a power grid. The actual rotational speed information of the target generator set is configured to indicate an actual rotational speed value of a generator rotor in the target generator set, and is usually expressed in revolutions per minute (RPM). The rotational speed value of the generator rotor can reflect the operating state of the target generator set when the target generator set is working, including the output power and frequency of the generator in the target generator set. The higher the rotational speed value of the generator rotor is, the more electric energy is generated by the generator in the target generator set, but the wear and energy consumption of the target generator set are also increased. By monitoring the actual rotational speed information of the target generator set, the operation of the generator in the target generator set can be known, problems can be found in time and adjusted for maintenance, and the safe and stable operation of the target generator set can be ensured.

As an example, the controller can collect the actual rotational speed information of the target generator set by using a speed measuring device of a governor. The speed measuring device of the governor measures the rotational speed value by collecting signals generated by a speed sensor on the generator rotor of the target generator set. The speed sensor is usually installed on the rotor of the generator of the target generator set and connected with the speed measuring device of the governor to transmit a speed signal to the speed measuring device of the governor for processing and analysis. The speed measuring device of the governor can accurately measure the actual rotational speed value of the generator rotor of the target generator set by analyzing the speed signal and obtain the actual rotational speed information, and send the actual rotational speed information to the controller.

Alternatively, the controller can collect the actual rotational speed information of the target generator set by using a generator-set-side speed measuring device. The generator-set-side speed measuring device is provided with two gear tooth speed measuring probes and can monitor the actual rotational speed value of the generator rotor of the target generator set in real time through a signal from an external speed pulse sensor or a voltage transformer. The generator-set-side speed measuring device serves as a backup for the speed measuring device of the governor. When the speed measuring device of the governor fails and cannot send the actual rotational speed information to the controller, the generator-set-side speed measuring device can accurately measure the actual rotational speed value of the generator rotor of the target generator set by using a pulse sensor or the like, and obtain the actual rotational speed information and send the actual rotational speed information to the controller.

In S200, a frequency signal is generated when the actual rotational speed information meets a preset rotational speed condition.

The rotational speed condition can be a range for limiting the rotational speed value of the generator rotor of the target generator set, and the frequency signal is configured to indicate operating frequency information of the target generator set corresponding to the rotational speed condition.

The operating frequency information of the target generator set is configured to indicate the frequency of an alternating current output by the target generator set, which is usually expressed in hertz (Hz). The operating frequency information of the target generator set can reflect the stability and operating state of the target generator set. A change in the operating frequency information can affect the operation of the target generator set and each device in the power supply system where the target generator set is located, including a generator, a transformer, a motor, or the like. If the frequency of the alternating current output by the target generator set deviates from a normal set frequency range value, the target generator set and the device in the power supply system where the target generator set is located may malfunction or be damaged.

In S300, state information of a target circuit breaker is obtained, and a pulse signal is generated based on the frequency signal when the state information meets a preset state condition.

The state information of the target circuit breaker refers to the state information of a contact of the circuit breaker and can be specifically configured to indicate the position of the contact of the circuit breaker. When the contact of the circuit breaker is in a switch-on position, the power supply system where the target generator set is located can normally supply power to the power grid. When the contact of the circuit breaker is in a switch-off position, the circuit of the power supply system where the target generator set is located is disconnected.

The preset state condition is configured to limit the position of the contact of the circuit breaker.

The pulse signal refers to a set signal. When the controller generates the pulse signal, the controller can set the bit Q15.7 to 1. Qm.n represents that data in the controller is represented by m bits for an integer part and n bits for a decimal part. The total number of bits required to represent the data is m+n+1. Q15.7 represents that the data with 15 bits for the integer part and 7 bits for the decimal part, and the controller sets these bits to 1.

In S400, a trip signal is generated according to the pulse signal, and the trip signal is sent to the target circuit breaker to control the target circuit breaker to be switched off.

The trip signal is configured to control the target circuit breaker to set the contact in the switch-off position, so that the circuit of the power supply system where the target generator set is located is controlled to be disconnected to prevent circuit damage or fire.

In the circuit breaker control method, the controller can monitor the rotational speed value of the generator rotor in the target generator set in real time, and obtain the actual frequency of the alternating current output by the target generator set when the rotational speed value is in a specific speed value range. Then, when it is determined that the contact of the target circuit breaker is in a position required by a preset state condition, the trip signal is automatically generated to control the circuit breaker to disconnect the circuit, so that intelligent disconnection control of the circuit breaker is achieved. The circuit breaker control method does not need manual control, consequently reducing labor cost, thereby promoting optimized allocation of power resources.

In some embodiments, the rotational speed condition includes that the actual rotational speed information indicates that the actual rotational speed value of the target generator set does not reach a first proportion of the preset rotational speed value, or the actual rotational speed information indicates that the actual rotational speed value of the target generator set is not zero.

For example, the step S200 includes: generating the frequency signal when the actual rotational speed information indicates that the actual rotational speed value of the target generator set does not reach the first proportion of the preset rotational speed value, or the actual rotational speed information indicates that the actual rotational speed value of the target generator set is not zero.

The first proportion of the preset rotational speed value may be 90% of the preset rotational speed value.

After the actual rotational speed value of the generator rotor in the target generator set is obtained, the controller further determines whether the actual rotational speed value of the generator rotor reaches the first proportion of the preset rotational speed value. When the actual rotational speed value does not reach the first proportion of the preset rotational speed value, the frequency signal is generated. When the actual rotational speed value reaches the first proportion of the preset rotational speed value, the controller further determines whether the actual rotational speed value of the generator rotor is zero. When the actual rotational speed value is not zero, the frequency signal is also generated.

In some embodiments, the state condition is that the target circuit breaker is in the switch-on position.

For example, the step S300 includes: generating the pulse signal based on the frequency signal when the state information indicates that the target circuit breaker is in the switch-on position.

The controller determines whether the contact of the circuit breaker is in the switch-on position after obtaining the state information of the contact of the circuit breaker, generates the pulse signal when the contact of the circuit breaker is in the switch-on position, and does not generate the pulse signal when the contact of the circuit breaker is not in the switch-on position.

In some embodiments, the circuit breaker control method further includes:
receiving a control signal, and controlling the target circuit breaker to be switched off according to the control signal.

The step S400 includes: generating the trip signal and sending the trip signal to the target circuit breaker to control the target circuit breaker to be switched off when the control signal is not received within a preset time period after the pulse signal is generated.

The control signal may be a low-frequency to interlock generator circuit breaker open signal, and the control signal is configured to instruct the contact of the target circuit breaker to be switched off to disconnect the circuit of the power supply system where the target generator set is located.

For example, the preset time period may be 2 seconds.

After the pulse signal is generated, when the control signal for controlling the target circuit breaker to be switched off, initiated by the staff from the outside, is not received within the preset time period, the controller automatically generates the trip signal to control the target circuit breaker to be switched off.

In some embodiments, the circuit breaker control method further includes:
stopping generation of the trip signal when a reset signal is obtained within the preset time period.

The reset signal refers to a signal for resetting the data set to 1 by the controller according to the pulse signal to 0.

After the pulse signal is generated, when the reset signal for resetting the data set to 1 by the controller according to the pulse signal to 0 is detected within the preset time period, the controller no longer generate the trip signal.

In some embodiments, the method for generating the reset signal includes:
continuously obtaining the actual rotational speed information of the target generator set within the preset time period after the pulse signal is generated, and generating the reset signal when the actual rotational speed information indicates that the actual rotational speed value of the target generator set reaches the first proportion of the preset rotational speed value, or the actual rotational speed information indicates that the actual rotational speed value of the target generator set is zero.

After the pulse signal is generated, the controller continuously obtains the actual rotational speed information of the target generator set within the preset time period, and determines whether a newly obtained actual rotational speed value of the generator rotor reaches the first proportion of the preset rotational speed value, and generates the reset signal when the newly obtained actual rotational speed value of the generator rotor reaches the first proportion of the preset rotational speed value, and further determines whether the actual rotational speed value of the generator rotor is zero, and also generates the reset signal when the actual rotational speed value of the generator rotor is zero.

It should be understood that, although the steps in the flowcharts involved in the above embodiments are shown in sequence as indicated by arrows, the steps are not necessarily executed in the order indicated by the arrows. Unless specifically stated herein, there is no strict order limitation for the execution of the steps, and the steps can be executed in other orders. Moreover, at least part of the steps in the flowcharts involved in the above embodiments can include multiple steps or stages, which are not necessarily executed at the same time, but can be executed at different times, and the execution order of the steps or stages is not necessarily sequential, but can be executed in turn or alternation with at least part of other steps, or steps or stages in other steps.

Based on the same inventive concept, a circuit breaker control apparatus for implementing the circuit breaker control method is further provided in an embodiment of the present disclosure. The solution for addressing the problem provided by the circuit breaker control apparatus is similar to that described in the circuit breaker control method, and therefore, specific definitions of the apparatus provided in one or more embodiments described below can refer to the definitions of the circuit breaker control method provided above, and thus will not be repeated here.

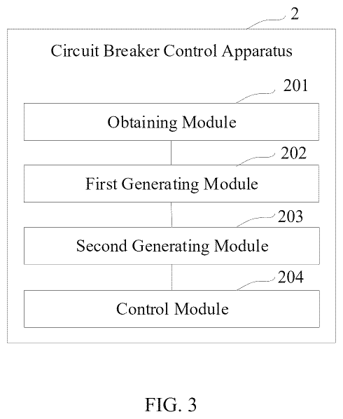

In some embodiments, as shown in FIG. 3, a circuit breaker control apparatus 2 is provided, including:
an obtaining module 201, configured to obtain actual rotational speed information of the target generator set;
a first generating module 202, configured to generate the frequency signal when the actual rotational speed information meets the preset speed condition;
a second generating module 203, configured to obtain the state information of the target circuit breaker, and generate the pulse signal based on the frequency signal when the state information meets the preset state condition; and
a control module 204, configured to generate the trip signal according to the pulse signal and send the trip signal to the target circuit breaker to control the target circuit breaker to be switched off.

In some embodiments, the rotational speed condition includes that the actual rotational speed information indicates that the actual rotational speed value of the target generator set does not reach a first proportion of the preset rotational speed value, or the actual rotational speed information indicates that the actual rotational speed value of the target generator set is not zero.

The first generating module 202 is further configured to:
generate the frequency signal when the actual rotational speed information indicates that the actual rotational speed value of the target generator set does not reach the first proportion of the preset rotational speed value, or the actual rotational speed information indicates that the actual rotational speed value of the target generator set is not zero.

In some embodiments, the state condition is that the target circuit breaker is in the switch-on position.

The second generating module 203 is further configured to:
generate the pulse signal based on the frequency signal when state information indicates that the target circuit breaker is in the switch-on position.

In some embodiments, the control module 204 is further configured to:
receive the control signal and control the target circuit breaker to be switched off according to the control signal; and
generate the trip signal and send the trip signal to the target circuit breaker to control the target circuit breaker to be switched off when no control signal is received within the preset time period after the pulse signal is generated.

In some embodiments, the control module 204 is further configured to:
stop the generation of the trip signal when the reset signal is obtained within the preset time period.

In some embodiments, the control module 204 is further configured to:
continuously obtain the actual rotational speed information of the target generator set within the preset time period after the pulse signal is generated, and generate the reset signal when the actual rotational speed information indicates that the actual rotational speed value of the target generator set reaches the first proportion of the preset rotational speed value or the actual rotational speed information indicates that the actual rotational speed value of the target generator set is zero.

Each of the modules in the apparatus can be implemented by software, hardware, or a combination thereof, in whole or in part. The modules can be embedded in or independent of a processor in a computer device in hardware, or stored in a memory in the computer device in software, so as to be called and executed by the processor to perform operations corresponding to the modules.

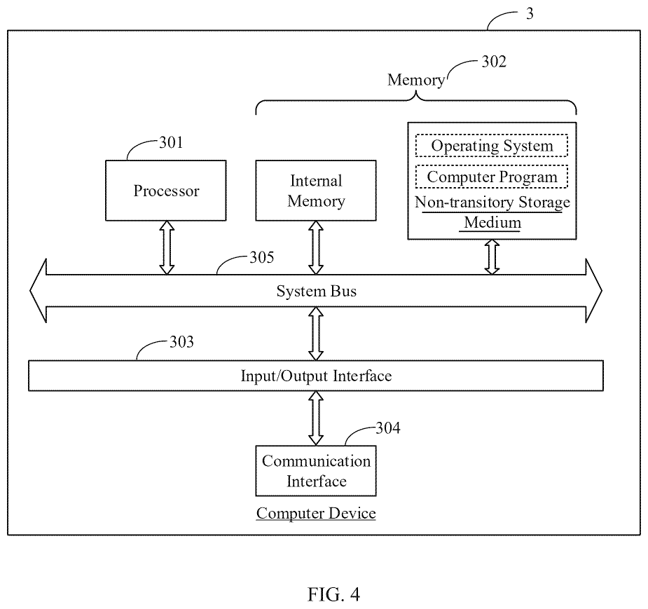

In some embodiments, a computer device 3 is provided, the computer device 3 can be a terminal, and an internal structure diagram of the computer device 3 can be as shown in FIG. 4. The computer device 3 includes a processor 301, a memory 302, an input/output interface 303, a communication interface 304, a display unit, and an input device. The processor 301, the memory 302, and the input/output interface 303 are connected through a system bus 305. The communication interface 304, the display unit, and the input device are connected to the system bus 305 through the input/output interface. The processor of the computer device is configured to provide calculation and control capabilities. The memory of the computer device includes a non-transitory storage medium and an internal memory. The non-transitory storage medium stores an operating system and a computer program. The internal memory provides an environment for running the operating system and the computer program in the non-transitory storage medium. The input/output interface of the computer device is configured to exchange information between the processor and an external device. The communication interface of the computer device is configured to perform wired or wireless communication with an external terminal, and the wireless communication can be implemented by means of Wi-Fi, mobile cellular network, near field communication (NFC), or other technologies. The computer program is executed by the processor to implement the circuit breaker control method. The display unit of the computer device is configured to form visible images, and the display unit may be a display screen, a projection device, or a virtual reality imaging device. The display screen may be a liquid crystal display screen or an electronic ink display screen. The input device of the computer device may be a touch layer overlaid on the display screen, may be a button, a trackball, or a touchpad arranged on a housing of the computer device, or may be an external key board, a touchpad, a mouse, or the like.

Those skilled in the art can understand that the structure shown in FIG. 4 is only a block diagram of part of the structure related to the present disclosure, and does not constitute a limitation on the computer device to which the present disclosure is applied. Specifically, the computer device can include more or fewer components than those shown in the drawings, or combine certain components, or have a different component arrangement.

In some embodiments, a non-transitory computer-readable storage medium is provided, and the non-transitory computer-readable storage medium stores a computer program. The computer program is executed by a processor to implement the steps of the circuit breaker control method.

In some embodiments, a computer program product is provided, and the computer program product includes a computer program. The computer program product is executed by a processor to implement the steps of the circuit breaker control method.

It is understood by a person skilled in the art that all or part of the processes in the method of the above embodiments can be implemented by using a computer program to instruct the related hardware. The computer program can be stored in a non-transitory computer-readable storage medium. When the computer program is executed, the processes of the embodiments of the methods can be implemented. Any reference to a memory, a database, or other medium in the embodiments of the present disclosure can include at least one of a non-volatile memory or a volatile memory. The non-volatile memory can include a read-only memory (ROM), a tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory can include a random access memory (RAM), an external cache memory, or the like. As a description rather than a limitation, the RAM can be in various forms, such as a static random access memory (SRAM) or a dynamic random access memory (DRAM). The database involved in the embodiments of the present disclosure can include at least one of a relational database or a non-relational database. The non-relational database can include a distributed database based on a blockchain, or the like, but is not limited thereto. The processor involved in the embodiments of the present disclosure can be a general-purpose processor, a central processing unit, a graphics processor, a digital signal processor, a programmable logic device, a data processing logic device based on quantum computing, or the like, but is not limited thereto.

Any technical features in the above embodiments can be combined arbitrarily. For brevity of description, not all possible combinations of the technical features in the above embodiments are described, but as long as the combinations of the technical features do not contradict each other, the combinations should be considered within the scope of the present disclosure.

The above embodiments only provide several implementations of the present disclosure, and the description is relatively specific and detailed, but this should not be understood as a limitation on the protection scope of the present disclosure. It should be noted that, for a person skilled in the art, several modifications and improvements can be made without departing from the inventive concept of the present disclosure, and these all belong to the protection scope of the present disclosure. Therefore, the protection scope of the present disclosure should be subject to the appended claims.

1. A circuit breaker control method, comprising:
obtaining actual rotational speed information of a target generator set;
generating a frequency signal when the actual rotational speed information meets a preset rotational speed condition;
obtaining state information of a target circuit breaker, and generating a pulse signal based on the frequency signal when the state information meets a preset state condition;
generating a trip signal according to the pulse signal, and sending the trip signal to the target circuit breaker to control the target circuit breaker to be switched off; and
stopping generation of the trip signal when a reset signal is obtained within a preset time period;
wherein generating the frequency signal when the actual rotational speed information meets the preset rotational speed condition comprises:
generating the frequency signal when the actual rotational speed information indicates that an actual rotational speed value of the target generator set does not reach a first proportion of a preset rotational speed value, or when the actual rotational speed information reaches the first proportion of the preset rotational speed value and the actual rotational speed information indicates that the actual rotational speed value of the target generator set is not zero;
wherein generating the reset signal comprises:
obtaining the actual rotational speed information of the target generator set continuously within the preset time period after the pulse signal is generated, and generating the reset signal when the actual rotational speed information indicates that the actual rotational speed value of the target generator set reaches the first proportion of the preset rotational speed value or the actual rotational speed information indicates that the actual rotational speed value of the target generator set is zero.

2. The method of claim 1, wherein the circuit breaker control method further comprises:
receiving a control signal, and controlling the target circuit breaker to be switched off according to the control signal; and
wherein generating the trip signal according to the pulse signal, and sending the trip signal to the target circuit breaker to control the target circuit breaker to be switched off comprises:
generating the trip signal, and sending the trip signal to the target circuit breaker to control the target circuit breaker to be switched off when no control signal is received within the preset time period after the pulse signal is generated.

3. The method of claim 2, wherein the state condition is that the target circuit breaker is in a switch-on position; and
generating the pulse signal based on the frequency signal when the state information meets the preset state condition comprises:
generating the pulse signal based on the frequency signal when the state information indicates that the target circuit breaker is in the switch-on position.

4. A circuit breaker control apparatus, comprising:
an obtaining module, configured to obtain actual rotational speed information of a target generator set;
a first generating module, configured to generate a frequency signal when the actual rotational speed information meets a preset rotational speed condition;
a second generating module, configured to obtain state information of a target circuit breaker, and generate a pulse signal based on the frequency signal when the state information meets a preset state condition;
a control module, configured to generate a trip signal according to the pulse signal, and send the trip signal to the target circuit breaker to control the target circuit breaker to be switched off;
the control module is further, configured to stop generation of the trip signal when a reset signal is obtained within a preset time period;
wherein generating the frequency signal when the actual rotational speed information meets the preset rotational speed condition comprises:
generating the frequency signal when the actual rotational speed information indicates that an actual rotational speed value of the target generator set does not reach a first proportion of a preset rotational speed value, or when the actual rotational speed information reaches the first proportion of the preset rotational speed value and the actual rotational speed information indicates that the actual rotational speed value of the target generator set is not zero;
wherein generating the reset signal comprises:
obtaining the actual rotational speed information of the target generator set continuously within the preset time period after generating the pulse signal, and generating the reset signal when the actual rotational speed information indicates that the actual rotational speed value of the target generator set reaches the first proportion of the preset rotational speed value or the actual rotational speed information indicates that the actual rotational speed value of the target generator set is zero.

5. A computer device, comprising a memory and a processor; wherein the memory stores a computer program, and the processor, when executing the computer program, implements operations for circuit breaker control; wherein the operations comprise:
obtaining actual rotational speed information of a target generator set;
generating a frequency signal when the actual rotational speed information meets a preset rotational speed condition;
obtaining state information of a target circuit breaker, and generating a pulse signal based on the frequency signal when the state information meets a preset state condition;
generating a trip signal according to the pulse signal, and sending the trip signal to the target circuit breaker to control the target circuit breaker to be switched off; and
stopping generation of the trip signal when a reset signal is obtained within a preset time period;
wherein generating the frequency signal when the actual rotational speed information meets the preset rotational speed condition comprises:
generating the frequency signal when the actual rotational speed information indicates that an actual rotational speed value of the target generator set does not reach a first proportion of a preset rotational speed value, or when the actual rotational speed information reaches the first proportion of the preset rotational speed value and the actual rotational speed information indicates that the actual rotational speed value of the target generator set is not zero;
wherein generating the reset signal comprises:
obtaining the actual rotational speed information of the target generator set continuously within the preset time period after the pulse signal is generated, and generating the reset signal when the actual rotational speed information indicates that the actual rotational speed value of the target generator set reaches the first proportion of the preset rotational speed value or the actual rotational speed information indicates that the actual rotational speed value of the target generator set is zero.

6. A non-transitory computer-readable storage medium, storing a computer program; wherein the computer program, when executed by a processor, implements the steps of the circuit breaker control method according to claim 1.

7. (canceled)

8. The method according to claim 1, wherein the frequency signal is configured to indicate operating frequency information of the target generator set corresponding to the rotational speed condition.

9. The method according to claim 1, wherein the pulse signal is a set signal.

10. The computer device according to claim 5, wherein the operations further comprise:
receiving a control signal, and controlling the target circuit breaker to be switched off according to the control signal; and
wherein generating the trip signal according to the pulse signal, and sending the trip signal to the target circuit breaker to control the target circuit breaker to be switched off comprises:
generating the trip signal, and sending the trip signal to the target circuit breaker to control the target circuit breaker to be switched off when no control signal is received within the preset time period after the pulse signal is generated.

11. The computer device according to claim 8, wherein the state condition is that the target circuit breaker is in a switch-on position, and generating the pulse signal based on the frequency signal when the state information meets the preset state condition comprises:
generating the pulse signal based on the frequency signal when the state information indicates that the target circuit breaker is in the switch-on position.
